(19) United States
(12) Patent Application Publication
(10) Pub. No.: US 2019/0374305 A1
(43) Pub. Date: Dec. 12, 2019

(54) DENTAL IMPLANT POSITIONING AND GUIDING ASSEMBLY

(71) Applicant: Sichuan HongzhengBoen Dental Technology Co., Ltd., Ziyang City (CN)

(72) Inventors: Hom-Lay WANG, Hsinchu City (TW); Debby DAI, Beijing (CN)

(21) Appl. No.: 16/032,984

(22) Filed: Jul. 11, 2018

(30) Foreign Application Priority Data
Jun. 8, 2018 (TW) 107119880

(51) Int. Cl. A61C 1/08

(52) U.S. Cl. CPC A61C 1/084

(57) ABSTRACT

A dental implant positioning and guiding assembly is disclosed in the present invention. The dental implant positioning and guiding assembly includes a positioning rod, a convex element, a concave element, a connector and a plurality of guiding elements. The positioning rod is utilized to be inserted into a drilled hole in a patient's oral model. The convex element has a through hole for holding the positioning rod. The concave element is positionally assemble with the convex element. The connector is fixed to one side of the concave element and has a contact surface with a surface contour matching an oral contour of the patient for engaging with the oral contour. Each of the guiding elements is positionally assembled with the concave element and has an open with a curve guiding surface for guiding the surgery operator to drill the at least one implant hole.

This application claims the benefit of Taiwan Patent Application Serial No. 107119880, filed Jun. 8, 2018, the subject matter of which is incorporated herein by reference.

### BACKGROUND OF INVENTION

### 1. Field of the Invention

The present invention is related to a positioning and guiding assembly, and more particularly is related to a dental implant positioning and guiding assembly.

### 2. Description of the Prior Art

Dental implant surgery is a procedure using an implant with a lower portion thereof interfaces with the bone as a basis to support and position a dental prosthesis on the upper portion of the implant. Because of the function, structure, and cosmesis of the implant is quite similar to the natural teeth, dental implant surgery has become the first recovery choice for the patient with missing teeth. Before the placing the implant, the dentist needs to drill an implant hole in the alveolar bone for placing the implant through the dental implant surgery. The dentist needs to drill a pilot hole first and expand the pilot hole by using progressively wider drills to form implant hole. A minor error during the drilling process may cause the failure of dental implant surgery. The deviations of position, angle, and depth of the implant hole may hurt the potential dangerous regions such as neighboring teeth, nerves, and maxillary sinus, and also increase the possibility of marginal bone loss surrounding the implant, missing dental papilla, atrophy of oral mucosa surrounding the implant, and failure of dental implant surgery.

In the conventional dental implant surgery, the dentist analyzes the bones surrounding the implant region by using dental X-ray and plans the implants. The dentist can only estimate the 3D anatomical structure indirectly based on the 2D image. During the actual clinic surgery, all the operations rely on the experience of the dentist, and the plan may not work precisely. Although the technology of digitized implant guides, i.e. using the computer to do the observation and measurement of bone morphology and the overall consideration to include the factors such as repair during follow-up, generate 3D guide model for full mouth scan 3D printing, emerges, but the technology has the following drawbacks, such as the design and printing operations need a long manufacturing period, the full mouse scan guide needs to be printed for both single missing tooth and multiple missing teeth, the cost is high, and the waiting time is long, which may not be acceptable to the patients, and thus the promotion for clinical usage is difficult. In addition, because the software needs a long training period and high hardware requirement, the implant guide needs to be transferred to an external manufacturer in general rather than being manufactured by the dental office directly, and thus it would be inconvenient for the dentist if the dentist needs to modify or adjust the plan during the clinical usage.

Moreover, because Chinese people usually has a small mouth opening, the operation space in patient's mouth would be small when placing the aforementioned full mouth scan digitized 3D printed guide, especially the area of back teeth, and thus the difficulty of dental implant surgery would be greatly enhanced. According to the published document, the ideal implant position (i.e. the position of the implant hole) is at least 2 mm away from the buccal side, 1 to 3 mm from the Cemento-enamel junction (CEJ), and at least 1.5 to 2 mm from the neighboring teeth. The position of the implant hole along three coordinates (buccal-lingual, mesial-distal, and the top coronal surface) is quite important for the success and beauty of dental implant.

In addition, in the conventional art, the full mouth scan guide includes a guiding hole for guiding the dentist, which needs to be completed together with the customized implant guide by using the 3D printing process, such that the printed guiding hole may not be exchangeable and a common dimension for mass production cannot be used, which may cause inconvenience for the dentist. In addition, the customized implant guide also has the problem of high cost.

In conclusion, the conventional art has the problems include: the implant precision for the dental implant surgery is low, the dental implant surgery cannot be completed rapidly and thoroughly right beside the dental chair, and the technology of full mouth digitized 3D printed guide needs a whole set of full mouse scan guide to be printed for both single missing tooth and multiple missing teeth, is unable to use a common dimension for mass production, has a high cost and a long waiting time is long.

### SUMMARY OF THE INVENTION

In view of the aforementioned problems of the conventional art that the implant precision for the dental implant surgery is low, the dental implant surgery cannot be completed rapidly and thoroughly right beside the dental chair, and the technology of full mouth digitized 3D printed guide needs a whole set of full mouse scan guide to be printed for both single missing tooth and multiple missing teeth, is unable to use a common dimension for mass production, has a high cost and a long waiting time is long. It is a main object of the present invention to provide a dental implant positioning and guiding assembly.

In order to resolve the problems of the conventional technologies, a dental implant positioning and guiding assembly, adapted for a surgery operator to drill at least one implant hole in an alveolar bone of a mouth of a patient, is provided in the present invention. The dental implant positioning and guiding assembly comprises a positioning rod, a convex element, a concave element, a connector, and a plurality of guiding elements.

The positioning rod is utilized to be inserted into a drilled hole provided in an oral model of the patient. The convex element has a through hole corresponding to the positioning rod for holding the positioning rod. The concave element is positionally assembled with the convex element. The connector is fixed to one side of the concave element and has a contact surface with a surface contour matching an oral contour of the patient for engaging with the oral contour. Each of the guiding elements is positionally assembled with the concave element and has an open with a curve guiding surface for guiding the surgery operator to drill the at least one implant hole.

Wherein, after the concave element is positionally assembled with the convex element, the surgery operator has the connector connected to the concave element, replaces the convex element and the positioning rod with one of the guiding elements, and places the connector, the concave element, and the one of the guiding elements into the mouth of the patient, and uses the connector to engage with the oral contour for drilling the at least one implant hole.

In accordance with an embodiment of the present invention, the positioning rod has an upper portion and a lower portion, the upper portion is a tapered circular column and the lower portion is a circular column, the upper portion is wider than the lower portion, the upper portion is tapered outward from a top to a bottom, and a horizontal cross-section surface of the upper portion is a circle and a vertical cross-section surface of the upper portion is a trapezoid.

In accordance with an embodiment of the present invention, the convex element of the dental implant positioning and guiding assembly has two engaging trenches at two sides thereof.

In accordance with an embodiment of the present invention, the concave element of the dental implant positioning and guiding assembly has two engaging protrusions at one end thereof corresponding to the connector for engaging with the engaging trenches at the two sides of the convex element.

In accordance with an embodiment of the present invention, the guiding element has two assembling trenches at two sides thereof, and the assembling trenches are utilized to be positionally assembled with the two engaging protrusions of the concave element.

In accordance with an embodiment of the present invention, a number of the guiding elements is four, and radii of curvature of the curved guiding surfaces of the four guiding elements are 2.2 mm, 2.8 mm, 3.5 mm, and 4.2 mm, respectively.

In accordance with an embodiment of the present invention, the connector is composed of a light cured material and is connected to the concave element by using a light curing process.

In accordance with an embodiment of the present invention, the connector and the concave element of the dental implant positioning and guiding assembly are integratedly formed by using 3D printing process.

In accordance with an embodiment of the present invention, the connector of the dental implant positioning and guiding assembly is connected to the concave element by using a thermal curing process.

In accordance with an embodiment of the present invention, the connector of the dental implant positioning and guiding assembly is engaged with the concave element.

In accordance with an embodiment of the present invention, the positioning rod, the convex element, the concave element, the connector and the guiding elements of the dental implant positioning and guiding assembly are formed by using 3D printing process.

In accordance with an embodiment of the present invention, the positioning rod, the convex element, the concave element, the connector and the guiding elements of the dental implant positioning and guiding assembly are formed by using ceramic mold casting process.

As mentioned, the dental implant positioning and guiding assembly provided in the present invention is capable to provide complete pre-surgical information, such as buccal-lingual position, mesial-distal position, direction, and angle, and thus the design and manufacturing of the implant guide can be completed beside the dental chair. Since the dentist is capable to access the best position of the implant hole, the possibility of future dental implant complications can be reduced, such that flexibility of clinical operation can be enhanced, and the cost is economical. At the same time, a clear positioning rule and regulation for implant hole can be defined to access the ideal position and angle of the implant hole so as to reduce surgical damage, shorten surgical time, reduce possibility of dental implant failure and dental implant complications.

The dental implant positioning and guiding assembly provided in the present invention has the advantages of remarkable positioning, easy recognition, precise positioning, the plugging and fixing design of the three elements connected to each other is quite convenient, and the position and angle thereof can be flexibly adjusted. The guiding element has the design corresponding to the radius of the dental implant drill to show the guiding capability and allow the dental implant drill to be placed from the side. Thus, the patient does not need to open the mouth widely, and the uncomfortable feeling to open the mouth widely during the conventional dental implant surgery can be alleviated. In addition to precisely define the implant position (the implant hole), the guiding element simplifies the complicated manufacturing process of implant guide to enhance the operation efficiency and position the location, depth, and direction of the implant to be placed so as to enhance success rate of the dental implant surgery and also reduce the surgical time.

The concave element and the convex element as well as the positioning rod can be positionally assembled one by one, the concave element and the guiding element can also be positionally assembled and disassembled easily, even in the mouth of the patient. By using the guiding elements with curved guiding surface of different radii of curvature to be selectively positionally assembled with the concave element, the guiding elements can be replaced easily without the need to take off the implant guide repeatedly from the mouth of the patient. Thus, in compared with the conventional technology implant guide, which needs to be taken off from the mouth of the patient repeatedly, disassemble the half circle plate in the positioning ring to change the radius of the positioning ring, the present invention is capable to save surgical time and make the operation more convenient.

### BRIEF DESCRIPTION OF THE DRAWINGS

The present invention will now be specified with reference to its preferred embodiment illustrated in the drawings, in which:

FIG. 1 is a perspective schematic view of a dental implant positioning and guiding assembly in accordance with a preferred embodiment of the present invention;

FIG. 2 is a schematic view showing the assembly of the positioning rod and the convex element of the dental implant positioning and guiding assembly in accordance with a preferred embodiment of the present invention;

FIG. 3 is a schematic view showing the cross section A-A in FIG. 2;

FIG. 4 is a top view showing the convex element and the guiding element of the dental implant positioning and guiding assembly in accordance with a preferred embodiment of the present invention; and

FIG. 5 to FIG. 5F are schematic views showing the usage of the dental implant positioning and guiding assembly in accordance with a preferred embodiment of the present invention.

### DESCRIPTION OF THE PREFERRED EMBODIMENT

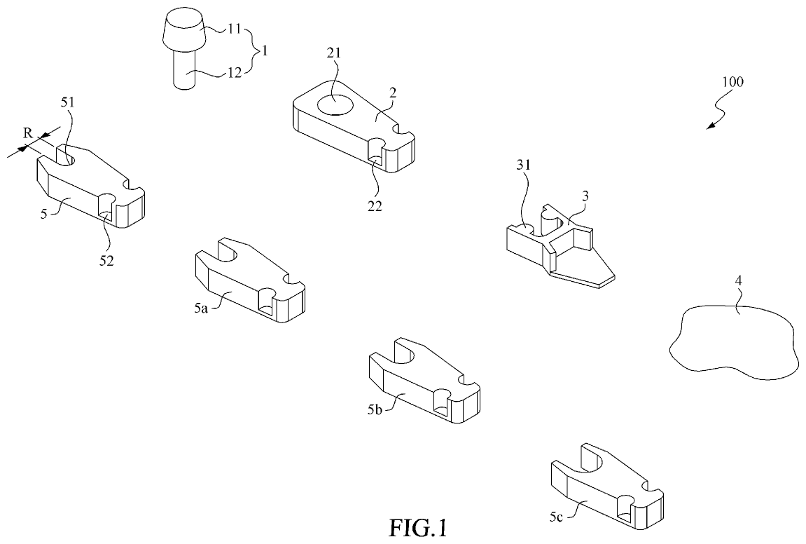

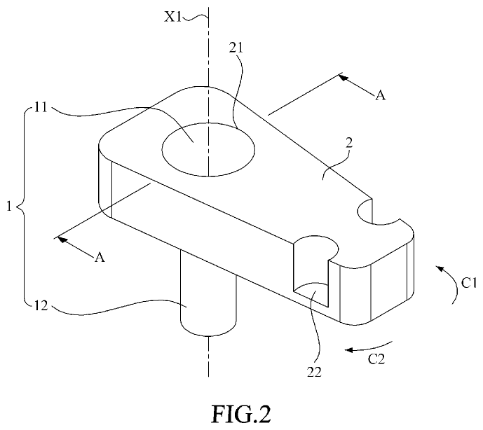

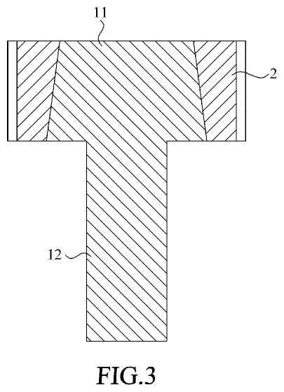

Please refer to FIG. 1 to FIG. 3, wherein FIG. 1 is a perspective schematic view of a dental implant positioning and guiding assembly in accordance with a preferred embodiment of the present invention; FIG. 2 is a schematic view showing the assembly of the positioning rod and the convex element of the dental implant positioning and guiding assembly in accordance with a preferred embodiment of the present invention; and FIG. 3 is a schematic view showing the cross section A-A in FIG. 2. As shown, the dental implant positioning and guiding assembly 100 comprises a positioning rod 1, a convex element 2, a concave element 3, a connector 4, and four guiding elements 5, 5a, 5b, and 5c. In the present embodiment, the positioning rod 1, the convex element 2, the concave element 3, and the guiding elements 5, 5a, 5b and 5c are manufactured by using 3D printing technology, however, the present invention is not limited thereto. For example, these elements can be manufactured by using ceramic mold casting technology.

The positioning rod 1 has an upper portion and 11a lower portion 12. The upper portion 11 is a tapered circular column and the lower portion 12 is a circular column. The upper portion 11 is wider than the lower portion 12 in general. To be more precisely, the upper portion 11 is a tapered circular column tapered outward from a top to a bottom. The horizontal cross-section surface of the upper portion 11 is a circle, the vertical cross-section surface of the upper portion 11 is a trapezoid, and the circles of the horizontal cross-section surfaces gradually increase from a top to a bottom.

The convex element 2 has a through hole 21 matching the upper portion 11 of the positioning rod 1 such that the convex element 2 can be removably held by the positioning rod 1. In addition, the convex element 2 also has a plurality of engaging trenches 22 (only one of them is labelled in the figure) for engaging with the convex element 3. In the present embodiment, the number of the engaging trenches 22 is two, which are located at the two sides of the convex element 2. Because the upper portion 11 of the positioning rod 1 has a shape of a tapered circular column, after the convex element 2 placed on the positioning rod 1, the surgery operator (i.e. the dentist) may rotate the convex element 2 centered at a reference axis X1 along a counterclockwise direction C1 or a clockwise direction C2. The reference axis X1 is extended from the line penetrating the centers of the circles on the horizontal cross-section surfaces of the upper portion 11, and thus the reference axis X1 may penetrate both the central position of the upper portion 11 and the central position of the penetrate hole 21.

The concave element 3 has two engaging protrusions 31 (only one of them is labelled in the figure) utilized for positionally engaging with the engaging trenches 22 of the convex element 2. Because the shape of the engaging protrusions 31 matches the shape of the engaging trenches 22, the engaging protrusion 31 can be closely assembled with the engaging trench 22, such that after the concave element 3 is positionally assembled with the convex element 2, no relative movement would occur and the positioning precision can be guaranteed. The other side of the concave element 3 opposite to the convex element 2 is utilized for connecting the connector 4. As the connector 4 is connected to the convex element 2, no relative movement would occur and the positioning precision can be guaranteed.

In the present embodiment, the connector 4 is made of light sensitive resin, however, the present invention is not limited thereto. The light sensitive resin is composed of light sensitive prepolymer, active diluent, and photosensitizer. Under the normal condition, the light sensitive resin is deformable. After being illuminated by ultraviolet light of a certain wavelength (250 nm to 380 nm), polymerization occurs to make the light sensitive resin solid. In the other embodiment, the connector 4 may be connected to the concave element 3 by using the thermal curing process or merely by mechanical assembling. Preferably, the connector 4 and the concave element 3 can be made by using 3D printing technology to have the connector 4 and the concave element 3 integratedly formed as a whole.

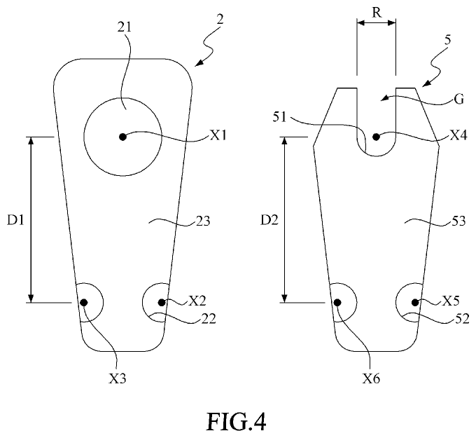

The difference between the guiding elements 5, 5a, 5b, and 5c is the radius of curvature. Take the guiding element 5 as an example. The guiding element 5 has an open G (labelled in FIG. 4), a curve guiding surface 51 formed in the open G, and two assembling trenches 52 at the two sides thereof respectively (only one of them is labelled in the figure). The curve guiding surface 51 has a diameter of curvature R, which is double the radius of curvature, i.e. 2.2 mm. The radius of curvature matches the radius of curvature of the drill head of at least one of the implant drills. Therefore, the surgery operator may press the implant drill against the curve guiding surface 51 and use the curve guiding surface 51 as a guide to drill an implant hole. The purpose of the assembling trench 52 is for positionally assembled with the concave element 3 to replace the convex element 2.

Similarly, each of the other guiding elements 5a, 5b, and 5c also has a radius of curvature, a curve guiding surface, and two assembling trenches at two sides thereof respectively. It should be mentioned that, the radius of curvature of the guiding element 5a is 2.8 mm, the radius of curvature of the guiding element 5b is 3.5 mm, and the radius of curvature of the guiding element 5c is 4.2 mm. However, the present invention is not limited thereto, the radius of curvature can be modified based on the statistical analysis of the patients to figure out if there has a better dimension.

Please refer to FIG. 4, which is a top view showing the convex element and the guiding element of the dental implant positioning and guiding assembly in accordance with a preferred embodiment of the present invention. As shown, the convex element 2 has a through hole 21, two engaging trenches 22, and a reference distance D1, the guiding element 5 has an open G, a curve guiding surface 51, two assembling trenches 52, and a reference distance D2.

The reference axis X1 penetrates the central position of the through hole 21. A reference axis X2 and a reference axis X3 are defined to penetrate the center of circle of the two engaging trenches 22 respectively. The reference axes X1, X2, and X3 are parallel each other. The reference distance D1 is defined as the distance from the reference axis X1 to the connecting line between the center of circle of the two engaging trenches 22. Similarly, a reference axis X4 is defined as the axis penetrating the center of curvature of the curve guiding surface 51. A reference axis X5 and a reference axis X6 are defined to penetrate center of circle of the two assembling trenches 52 respectively. The reference axes X4, X5, and X6 are parallel to each other. The reference distance D2 is defined as the distance from the reference axis X4 to the center of circle of the two assembling trenches 22. The reference distance D1 is identical to the reference distance D2. The guiding elements 5a, 5b, and 5c also possess the reference distances identical to the aforementioned reference distance D1 and D2.

Moreover, the convex element 2 also has an engaging arm 23, and the guiding element 5 also has an assembling arm 53. The engaging arm 23 is the portion above the connecting line between the reference axes X2 and X3, and the assembling arm 53 is the portion above the connecting line between the reference axes X5 and X6. The engaging arm 23 has the advantage that as the surgery operator wants to assemble the convex element 2 with the concave element 3 or to disassemble the convex element 2 from the concave element 3, the surgery operator may hold the convex element to generate an arm of force between the holding position and the connecting position between the convex element 2 and the concave element 3 (i.e. the connecting position between the engaging trench 22 and the engaging protrusion 31). The point to apply the force is the position on the convex element 2 held by the surgery operator, and the pivot point is the connecting position between the convex element 2 and the concave element 3. The force applied by the surgery operator may generate a torque to make operations to assemble the convex element 2 with the concave element 3 or to disassemble the convex element 2 from the concave element 3 easier. Similarly, the assembling arm 53 is helpful for making the operations to assemble the guiding element 5 with the concave element 3 or to disassemble the guiding element 5 from the concave element 3 easier.

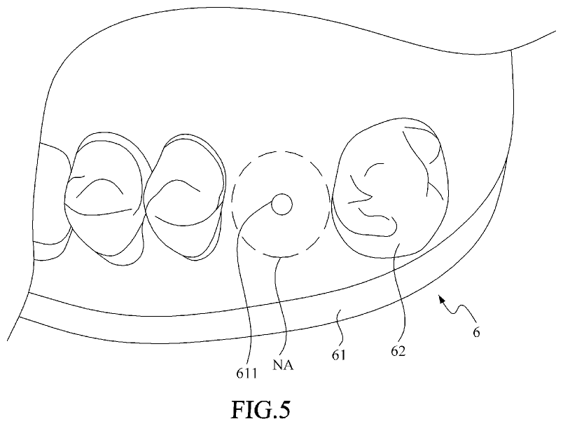

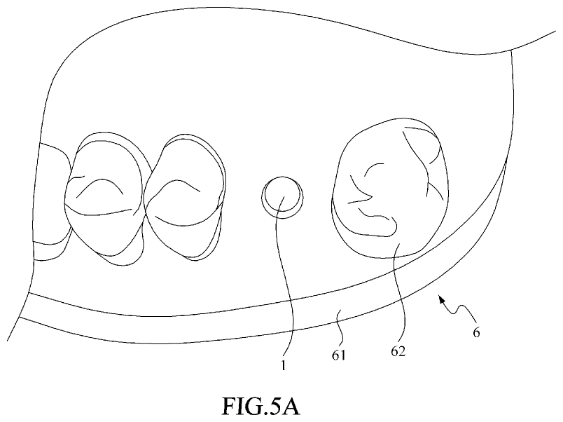

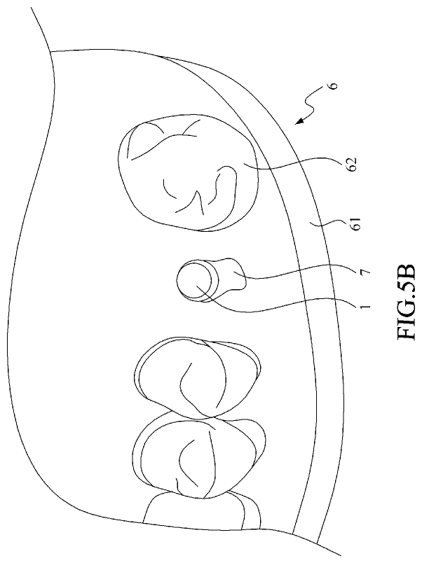

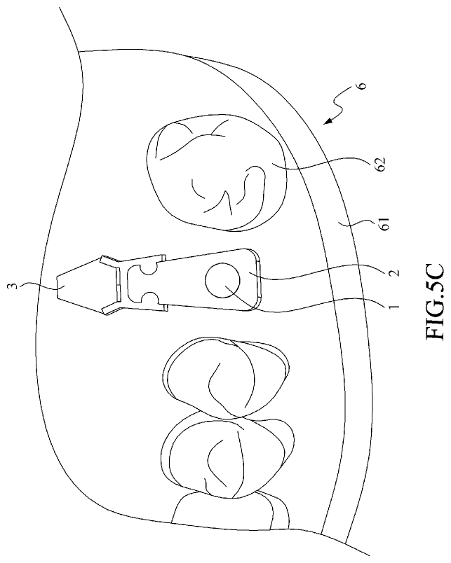

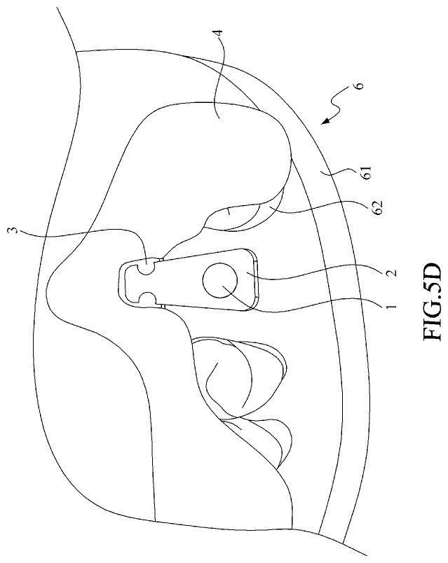

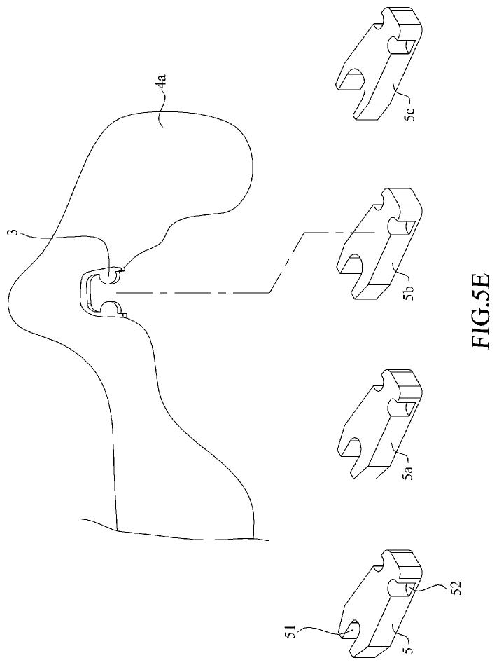

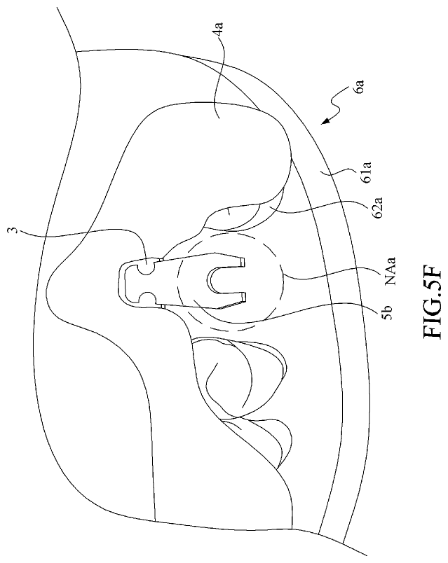

Please refer to FIG. 1, and FIG. 5 to FIG. 5F, wherein FIG. 5 to FIG. 5F are schematic views showing the usage of the dental implant positioning and guiding assembly in accordance with a preferred embodiment of the present invention. As shown, an oral panoramic film and a periapical film of a patient are shot in advance, and an oral model 6 of the patient is made. The oral model 6 includes an alveolar bone 61, a plurality of teeth 62 (only one of them is labelled), and an area of missing tooth NA. The surgery operator drills a drilled hole 611 in the area of missing tooth NA in advance. In the present embodiment, the area of missing tooth NA only has one missing tooth 62 and thus only one drilled hole 611 is needed. However, if the area of missing tooth NA has multiple missing teeth 62, multiple drilled holes 611 corresponding to the number of the missing teeth 62 would be needed. The ideal drilling position is defined and marked in the oral model 6 based on rule that the drilled hole 611 is at least 2 mm away from the buccal side, 1 to 3 mm from the Cemento-enamel junction (CEJ), and at least 1.5 to 2 mm from the neighboring teeth. The suitable implant position is at least 2 mm away from the buccal side, and at least 1.5 to 2 mm from the neighboring teeth (3 mm from the neighboring implant). In addition, the radius of the drilled hole 611 is corresponding to the radius of the lower portion 11 of the positioning rod 1. In the present embodiment, dental drill no. 8 is used by the surgery operator to drill the drilled hole 611.

Thereafter, the surgery operator inserts the lower portion 11 of the positioning rod 1 into the drilled hole 611 and checks the potion and angle of the positioning rod 1 based on the oral panoramic film and the periapical film. Then, the surgery operator uses a cutting tool to form a hollow space surrounding the positioning rod 1 to prevent leakage of a dental liquid glue 7. Thereafter, the surgery operation takes out the position rod 1, injects some dental liquid glue 7 in the drilled hole 611, and inserts the positioning rod 1 into the drilled hole 611 again to have the positioning rod 1 fixed in the drilled hole 611 by the dental liquid glue 7.

As the positioning rod 1 is fixed, the surgery operator may use the positioning rod 1 to held the convex element 2. Because the convex element 2 is rotatably held by the positioning rod 1 (as shown in FIG. 2), the surgery operator may rotate the convex element 2 to a suitable angle based on the position of the area of missing tooth NA to facilitate the operation. For example, if the area of missing tooth NA is located in the area of incisor, the convex element 2 may be rotated to align with the surgery operator, if the area of missing tooth NA is located in the area of back teeth, the convex element 2 may be rotated to the angle suitable for the surgery operator to drill the implant hole.

Thereafter, the surgery operator has the engaging protrusion 31 of the concave element 3 positionally assembled with the engaging trench 22 of the convex element 2, and has the connector 4 fixed to the side of the concave element 3 opposite to the convex element 2. Because the concave element 3 can be positionally assembled with the convex element 2, no relative movement between the concave element 3 and the convex element 2 would occur. In addition, because the connector 4 is fixed to the concave element 3, no relative movement between the connector 4 and the concave element 3 would occur. The connector 4 has a contact surface with a surface contour matching an oral contour of the patient. The oral contour represents at least one or a combination selected from the group composed of the tooth 62 (the tooth contour), the alveolar bone 61, the hard palate contour, and gum contour, for engaging with at least one of the teeth 62a, the alveolar bone 61a, the hare palate and the gum when being placed in a mouth 6a of the patient, so as to enhance the precision of the implant hole. In addition, the contact surface is located on the side facing the oral contour of the patient and thus is not shown in the figure.

In the present embodiment, the connector 4 is fixed to the concave element 3, covers a plurality of teeth 622 and a portion of the alveolar bone 61, and solidified by the illumination of the light with a certain wavelength to form the solidified connector 4a.

Finally, the surgery operator removes the connector 4a, the concave element 3, the convex element 2, and the positioning rod 1 from the oral model 6, and selects one of the guiding elements 5, 5a, 5b, and 5c according to the need of the patient positionally assembled with the concave element 3 placed into the mouth 6a of the patient for the drilling operation of the implant hole. Because the reference distance of the guiding element 5, 5a, 5b, and 5c is identical to the reference distance D1 of the convex element 2 (labelled in FIG. 4), the drilling position in the mouth 6a guided the curve guiding surface of the guiding element would be corresponding to the position of the drilled hole 611 in the oral model 6 with the positioning rod 1 inserted thereto so as to enhance the precision of drilling operation for the implant hole. In the present embodiment, the surgery operator selects the guiding element 5b for the following operation. The guiding element 5b is utilized for drilling the implant hole of the premolars, the guiding element 5 is suitable for the lower incisors and the side incisors, the guiding element 5a is suitable for the upper incisors, canines, and the center incisors, and the guiding element 5c is suitable for the molars.

Preferably, the surgery operator may drill the hole step by step to expand the implant hole from a small one to a large one. For example, if it is needed to drill the implant hole by using the guiding element 5b, the dentist may drill an implant hole by using the guiding element 5 first, and then expand the drilled implant hole by using the guiding element 5a, and finally use the guiding element 5b to drill the implant hole in correspondence with the need of the patient. Similarly, if it is needed to drill the implant hole by using the guiding element 5a, the guiding element 5 would be used before using the guiding element 5a; if it is needed to drill the implant hole by using the guiding element 5c, the guiding element 5, the guiding element 5a, and the guiding element 5b would be used in a serial before using the guiding element 5c. The step by step manufacturing method is helpful for preventing the error caused by a greater vibration when drilling a large hole directly, and thus the precision of the implant hole can be enhanced.

It should be mentioned that the oral model 6 is manufactured based on the mouth 6a, and thus the alveolar bone 61 of the oral model 6 is corresponding to an alveolar bone 61a of the actual mouth 6a, the plurality of teeth 62 of the oral model 6 is corresponding to the plurality of teeth 62a of the actual mouth 6a, and the area of missing tooth NA of the oral model 6 is corresponding to the area of missing tooth NAa of the actual mouth 6a. Thus, when placing the connector 4a with the contact surface matching the oral contour of the oral model 6 into the mouth 6a of the patient, the connector 4a may precisely engage with the teeth 62a and the alveolar bone 61a so as to prevent relative movement from happening to cause positioning errors.

The case of single missing tooth is provided in the present embodiment as an example, but the present invention is not limited thereto. The dental implant positioning and guiding assembly 1 provided in the present invention can also be used in the dental implant surgery with multiple missing teeth.

In conclusion, the dental implant positioning and guiding assembly provided in the present invention makes the positioning operation more convenient and precise. The plugging and fixing design of the three elements connected to each other is quite convenient and the position and angle thereof can be flexibly adjusted. The guiding element has the design corresponding to the radius of the dental implant drill to show the guiding capability and allow the dental implant drill to be placed from the side. Thus, the patient does not need to open the mouth widely, and the uncomfortable feeling to open the mouth widely during the conventional dental implant surgery can be alleviated. In addition to precisely define the implant position (the implant hole), the guiding element simplifies the complicated manufacturing process of implant guide to enhance the operation efficiency and position the location, depth, and direction of the implant to be placed so as to enhance success rate of the dental implant surgery and also reduce the surgical time.

The conventional digitized implant guide, which uses the computer to do the observation and measurement of bone morphology and to perform the overall consideration to include the factors such as repair during follow-up, generate 3D guide model for full mouth scan 3D printing, has the following drawbacks, such as the design and printing operations need a long manufacturing period, the full mouse scan guide needs to be printed for both single missing tooth and multiple missing teeth, the cost is high, and the waiting time is long.

In addition, the structure of the positioning ring of the conventional implant guide is a whole circle, during the operation, the mark on the dental drill would be shielded by the positioning ring, and thus it would be difficult for the dentist to control the drilling depth precisely. In contrast, the dental implant positioning and guiding assembly features the guiding element with an open, the structure of the guiding element is a semi-circle or with both ends extended to show a U-shape like structure. The guiding element not only has the guiding capability but also allows the surgery operator (i.e. the dentist) to read the mark on the dental drill clearly such that the drill depth can be precisely defined. In addition, the guiding element allows the surgery to be operated without the need to open the mouth of the patient widely such that the uncomfortable feeling to open the mouth widely during the conventional dental implant surgery can be alleviated.

The conventional implant guide also has the problem of complicated operation procedure. If the dentist wants to use an implant drill with a different radius, he needs to replace the original implant guide by an implant guide with a hole corresponding to the radius of the implant drill. That is, for each patient, at least four implant guides should be made. In addition, during the implant surgery, the operations such as placing the implant guide, taking off the implant guide, and changing the implant guide should be repeated several times. In contrast, the dental implant positioning and guiding assembly provided in the present invention features the plurality of guiding elements with different radii of curvature to be positionally assembled with the concave element, which can be assembled or disassembled easily, and thus only one implant guide (i.e. the connector and the concave element fixed thereto) is needed to be made for each of the patients. In addition, during the implant surgery, the surgery operator (i.e. the dentist) only needs to change the guiding element without the need to do the operations such as placing the implant guide, taking off the implant guide, and changing the implant guide, and thus the cost is reduced, the efficiency is enhanced, and the surgery procedure is simplified.

While the present invention has been particularly shown and described with reference to a preferred embodiment, it will be understood by those skilled in the art that various changes in form and detail may be without departing from the spirit and scope of the present invention.

What is claimed is:

1. A dental implant positioning and guiding implant, adapted for a surgery operator to drill at least one implant hole in an alveolar bone of a mouth of a patient, comprising:
a positioning rod, utilized to be inserted into a drilled hole provided in an oral model of the patient;
a convex element, having a through hole corresponding to the positioning rod for holding the positioning rod;
a concave element, positionally assembled with the convex element;
a connector, fixed to one side of the concave element and having a contact surface with a surface contour matching an oral contour of the patient for engaging with the oral contour; and
a plurality of guiding elements, each of the guiding elements being positionally assembled with the concave element and having an open with a curve guiding surface for guiding the surgery operator to drill the at least one implant hole;
wherein, after the concave element is positionally assembled with the convex element, the connector is connected to the concave element, the convex element and the positioning rod are replaced with one of the guiding elements, and the connector, the concave element, and the one of the guiding elements are placed into the mouth of the patient, and the connector is used to engage with the oral contour for drilling the at least one implant hole.

2. The dental implant positioning and guiding assembly of claim 1, wherein the positioning rod has an upper portion and a lower portion, the upper portion is a tapered circular column and the lower portion is a circular column, the upper portion is wider than the lower portion, the upper portion is tapered outward from a top to a bottom, and a horizontal cross-section surface of the upper portion is a circle and a vertical cross-section surface of the upper portion is a trapezoid.

3. The dental implant positioning and guiding assembly of claim 1, wherein the convex element has two engaging trenches at two sides thereof.

4. The dental implant positioning and guiding assembly of claim 3, wherein the concave element has two engaging protrusions at one end thereof corresponding to the connector for engaging with the engaging trenches at the two sides of the convex element.

5. The dental implant positioning and guiding assembly of claim 4, wherein each of the guiding elements has two assembling trenches at two sides thereof, and the assembling trenches are utilized to be positionally assembled with the two engaging protrusions of the concave element.

6. The dental implant positioning and guiding assembly of claim 1, wherein a number of the guiding elements is four, and radii of curvature of the curved guiding surfaces of the four guiding elements are 2.2 mm, 2.8 mm, 3.5 mm, and 4.2 mm, respectively.

7. The dental implant positioning and guiding assembly of claim 1, wherein the connector is composed of a light cured material and is connected to the concave element by using a light curing process.

8. The dental implant positioning and guiding assembly of claim 1, wherein the connector and the concave element are integratedly formed by using 3D printing process.

9. The dental implant positioning and guiding assembly of claim 1, wherein the connector is connected to the concave element by using a thermal curing process.

10. The dental implant positioning and guiding assembly of claim 1, wherein the connector is engaged with the concave element.

11. The dental implant positioning and guiding assembly of claim 1, wherein the positioning rod, the convex element, the concave element, the connector and the guiding elements are formed by using 3D printing process.

12. The dental implant positioning and guiding assembly of claim 1, wherein the positioning rod, the convex element, the concave element, the connector and the guiding elements are formed by using ceramic mold casting process.
